(19) United States
(12) Patent Application Publication
(10) Pub. No.: US 2026/0308044 A1
(43) Pub. Date: Oct. 8, 2026

(54) GLASS COMPOSITIONS THAT ENABLE HIGH COMPRESSIVE STRESS

(71) Applicant: CORNING INCORPORATED, CORNING, NY (US)

(72) Inventor: Timothy Michael Gross, Painted Post, NY (US)

(21) Appl. No.: 19/457,584

(22) Filed: Jan. 23, 2026

Related U.S. Application Data
(62) Division of application No. 17/263,260, filed on Jul. 30, 2019, now abandoned.
(60) Provisional application No. 62/714,404, filed on Aug. 3, 2018.

(51) Int. Cl. C03C 3/087; C03C 21/00

(52) U.S. Cl. CPC C03C 3/087; C03C 21/002; C03C 2203/52

(57) ABSTRACT

Alkali aluminosilicate glasses that may be ion exchanged to achieve ultra-high peak compressive stress. The glasses may be ion exchanged to achieve a peak compressive stress of at least about 1000 MPa and up to about 1500 MPa. The high peak compressive stress provides high strength for glasses with shallow flaw size distributions. These glasses have high Young's moduli, which correspond to high fracture toughness and improved failure strength and are suitable for high-strength cover glass applications that experience significant bending stresses in use such as, for example, as cover glass in flexible displays.

### CROSS-REFERENCE TO RELATED APPLICATION

This application is a divisional application of, and claims the benefit of priority under 35 U.S.C. § 120 of U.S. application Ser. No. 17/263,260, filed on Jan. 26, 2021, which is a national stage application under 35 U.S.C. § 371 of International Application No. PCT/US2019/044010, filed on Jul. 30, 2019, which claims the benefit of priority under 35 U.S.C. § 119 of U.S. Provisional Application Ser. No. 62/714,404 filed on Aug. 3, 2018, the content of which is relied upon and incorporated herein by reference in its entirety.

### FIELD

The disclosure relates to a family of glass compositions that can be ion-exchanged to achieve ultra-high peak compressive stress. More particularly, the disclosure relates to chemically strengthened glasses with sufficiently high peak compressive stress to arrest shallow surface flaws. Even more particularly, the disclosure relates to high strength cover glass in applications where significant bending stresses are experienced in-use, e.g., as cover glass for flexible displays.

### TECHNICAL BACKGROUND

Glasses used for displays in electronic devices such as cellular phones, smart phones, tablets, watches, video players, information terminal (IT) devices, laptop computers, and the like are typically chemically or thermally tempered to produce a surface compressive layer. This compressive layer serves to arrest flaws that can cause failure of the glass.

Foldable displays for electronic applications may benefit from thin, bendable glass. When subjected to bending, however, the beneficial flaw-arresting effect of the surface compressive layer is reduced to the extent that surface flaws are deeper than the compressive layer, thus causing the glass to fail when bent.

### SUMMARY

The present disclosure provides a family of alkali aluminosilicate glasses that may be ion exchanged to achieve ultra-high peak compressive stress. The glasses described herein may be ion exchanged to achieve a peak compressive stress of about 1000 MPa or more, and up to about 1500 MPa. The high peak compressive stress provides high strength for glasses with shallow flaw size distributions. These glasses have high Young's moduli, which correspond to high fracture toughness and improved failure strength. The glasses described herein are suitable for high-strength cover glass applications that experience significant bending stresses in use, for example, as cover glass in flexible and foldable displays. The high peak compressive stress allows the glass to retain net compression and thus contain surface flaws when the glass is subjected to bending around a tight radius. The high fracture toughness also assists in preventing fracture from applied stresses (e.g. from bending) for a given flaw population which can be introduced during processing of the glass and/or during use thereof in a device.

Accordingly, one aspect of the disclosure is to provide an ion exchangeable alkali aluminosilicate glass. As used herein, “ion exchangeable” means that the glass composition contains one or more first metal ions that may be replaced with a plurality of second metal ions to form a compressive stress in the glass. The first ions may be ions of lithium, sodium, potassium, and rubidium. The second metal ions may be ions of one of sodium, potassium, rubidium, and cesium, with the proviso that the second alkali metal ion has an ionic radius greater than the ionic radius of the first alkali metal ion. The second metal ion is present in the glass-based substrate as an oxide thereof (e.g., Na₂O, K₂O, Rb₂O, Cs₂O or a combination thereof). The glasses comprise about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %). The alkali aluminosilicate glass is substantially free of each SrO, BaO, B₂O₃, P₂O₅, and K₂O.

A second aspect of the disclosure is to provide an ion exchanged glass. The ion exchanged glass is an alkali aluminosilicate glass comprising about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %). The ion exchanged glass is substantially free of each SrO, BaO, B₂O₃, P₂O₅, and K₂O. The ion exchanged glass has a thickness t of up to about 4 mm and a compressive layer extending from a surface of the ion exchanged glass to a depth of compression (DOC) in the ion exchanged glass, wherein the compressive layer has a peak compressive stress of about 1000 MPa or more, and in some embodiments the peak compressive stress is at the surface of the ion exchanged glass.

A third aspect of the disclosure is to provide a method of strengthening a glass that is capable of resisting significant bending stresses. The method comprises: immersing a glass article in an ion exchange medium comprising at least one potassium salt, wherein the at least one potassium salt comprises about 50 wt % of the ion exchange medium; and ion exchanging the glass article while immersed in the ion exchange medium for a predetermined time period in a range from about 1 hour to about 24 hours at a predetermined temperature in a range from about 350° C. to about 480° C. to achieve a compressive layer extending from a surface to a depth of compression DOC and having a peak compressive stress of about 1000 MPa or more, and in some embodiments the peak compressive stress is at a surface of the ion exchanged glass. The glass article comprises an alkali aluminosilicate glass, the alkali aluminosilicate glass comprising about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %), and wherein the alkali aluminosilicate glass is substantially free of each SrO, BaO, B₂O₃, P₂O₅, and K₂O.

Various features of the disclosure may be combined in any and all combinations, and for example according to the various following embodiments.

Embodiment 1. An alkali aluminosilicate glass comprising:
a. about 17 or more mol % Al₂O₃;
b. Na₂O;
c. MgO; and
d. CaO, wherein Al₂O₃(mol %)+RO(mol %)≥21 mol %, where RO(mol %)=MgO(mol %)+CaO(mol %)+ZnO(mol %), wherein the alkali aluminosilicate glass is substantially free of each SrO, BaO, B₂O₃, P₂O₅, and K₂O, and wherein the alkali aluminosilicate glass is ion exchangeable.

Embodiment 2. The alkali aluminosilicate glass of Embodiment 1, wherein the alkali aluminosilicate glass comprises a thickness of up to about 4 mm and is ion exchangeable to achieve a compressive layer extending from a surface of the alkali aluminosilicate glass to a DOC and comprising a peak compressive stress of about 1000 or more MPa.

Embodiment 3. The alkali aluminosilicate glass of Embodiment 2 or Embodiment 3, wherein the alkali aluminosilicate glass comprises a thickness of up to about 100 μm.

Embodiment 4. The alkali aluminosilicate glass of Embodiment 3, wherein the alkali aluminosilicate glass comprises an absence of failure when held for 60 minutes at about 25° C. and about 50% relative humidity and at a bend radius of at least one of: 5 mm; 4 mm; or 3 mm.

Embodiment 5. The alkali aluminosilicate glass of any one of Embodiments 2-4, wherein the peak compressive stress is less than or equal to about 1500 MPa.

Embodiment 6. The alkali aluminosilicate glass of any one of Embodiments 1-5, wherein the alkali aluminosilicate glass comprises a Young's modulus in a range from about 80 GPa to about 90 GPa.

Embodiment 7. The alkali aluminosilicate glass of any one of Embodiments 1-6, further comprising Li₂O.

Embodiment 8. The alkali aluminosilicate glass of Embodiment 7, wherein the alkali aluminosilicate glass is ion exchangeable to achieve a compressive layer extending from a surface to a DOC of about 10% or more of thickness.

Embodiment 9. The alkali aluminosilicate glass of any one of Embodiments 1-8, wherein the alkali aluminosilicate glass is ion exchangeable to achieve a depth of layer of potassium ions of from about 4 microns to about 40 microns.

Embodiment 10. The alkali aluminosilicate glass of any one of Embodiments 1-9, further comprising ZnO.

Embodiment 11. The alkali aluminosilicate glass of any one of Embodiments 1-10, wherein CaO(mol %)/RO(mol %)>0.4.

Embodiment 12. The alkali aluminosilicate glass of any one of Embodiments 1-11, wherein the alkali aluminosilicate glass comprises a liquidus viscosity in a range from about 5 kP to about 200 kP.

Embodiment 13. The alkali aluminosilicate glass of any one of Embodiments 1-12, wherein the alkali aluminosilicate glass comprises: from about 52 mol % to about 61 mol % SiO₂; from about 17 mol % to about 23 mol % Al₂O₃; from 0 mol % to about 7 mol % Li₂O; from about 9 mol % to about 20 mol % Na₂O; from greater than 0 mol % to about 5 mol % MgO; from greater than 0 mol % to about 5 mol % CaO; and from greater than 0 mol % to about 2 mol % ZnO.

Embodiment 14. The alkali aluminosilicate glass of Embodiment 13, wherein the alkali aluminosilicate glass comprises: from about 55 mol % to about 61 mol % SiO₂; from about 17 mol % to about 20 mol % Al₂O₃; from 4 mol % to about 7 mol % Li₂O; from about 9 mol % to about 15 mol % Na₂O; from greater than 0 mol % to about 5 mol % MgO; from greater than 0 mol % to about 5 mol % CaO; and from greater than 0 mol % to about 2 mol % ZnO.

Embodiment 15. The alkali aluminosilicate glass of any one of Embodiments 1-14, wherein the alkali aluminosilicate glass forms at least a portion of a flexible display.

Embodiment 16. An ion exchanged glass, wherein the ion exchanged is an alkali aluminosilicate glass comprising:
a. about 17 or more mol % Al₂O₃;
b. Na₂O;
c. MgO; and
d. CaO, wherein Al₂O₃(mol %)+RO(mol %)≥21 mol %, where RO(mol %)=MgO(mol %)+CaO(mol %)+ZnO(mol %), wherein the alkali aluminosilicate glass is substantially free of each SrO, BaO, B₂O₃, P₂O₅, and K₂O, and wherein the ion exchanged glass comprises a thickness of up to about 4 mm comprises a compressive layer extending from a surface of the ion exchanged glass to a DOC, and comprises a peak compressive stress of about 1000 or more MPa.

Embodiment 17. The ion exchanged glass of Embodiment 16, wherein the ion exchanged glass comprises a thickness of up to about 100 μm.

Embodiment 18. The ion exchanged glass of Embodiment 16 or Embodiment 17, wherein the ion exchanged glass comprises an absence of failure when held for 60 minutes at about 25° C. and about 50% relative humidity and at a bend radius of at least one of: 5 mm; 4 mm; or 3 mm.

Embodiment 19. The ion exchanged glass of any one of Embodiments 16-18, wherein the peak compressive stress is less than or equal to about 1500 MPa.

Embodiment 20. The ion exchanged glass of any one of Embodiments 16-19, wherein the ion exchanged glass further comprises Li₂O, and wherein the DOC is about 10% or more of thickness.

Embodiment 21. The alkali aluminosilicate glass of any one of Embodiments 16-20, wherein the ion exchanged glass comprises a depth of layer of potassium ions of from about 4 microns to about 40 microns.

Embodiment 22. The ion exchanged glass of any one of Embodiments 16-21, wherein the ion exchanged glass comprises: from about 52 mol % to about 61 mol % SiO₂; from about 17 mol % to about 23 mol % Al₂O₃; from 0 mol % to about 7 mol % Li₂O; from about 9 mol % to about 20 mol % Na₂O; from greater than 0 mol % to about 5 mol % MgO; from greater than 0 mol % to about 5 mol % CaO; and from greater than 0 mol % to about 2 mol % ZnO.

Embodiment 23. The ion exchanged glass of Embodiment 22, wherein the alkali aluminosilicate glass comprises: from about 55 mol % to about 61 mol % SiO₂; from about 17 mol % to about 20 mol % Al₂O₃; from 4 mol % to about 7 mol % Li₂O; from about 9 mol % to about 15 mol % Na₂O; from greater than 0 mol % to about 5 mol % MgO; from greater than 0 mol % to about 5 mol % CaO; and from greater than 0 mol % to about 2 mol % ZnO.

Embodiment 24. The ion exchanged glass of any one of Embodiments 16-23, wherein the ion exchanged glass forms at least a portion of a flexible display.

Embodiment 25. The ion exchanged glass of any one of Embodiments 16-24, wherein the ion exchanged glass forms at least one of a cover glass at or over a display of an electronic device or apportion of a housing of the electronic device.

Embodiment 26. An electronic device comprising the ion exchanged glass of any one of Embodiments 16-25, the electronic device comprising a housing comprising front, back, and side surfaces, electrical components which are at least partially internal to the housing, a display at or adjacent to the front surface of the housing, and a cover glass over the display, wherein at least one of the cover glass and the housing comprise the ion exchanged glass, wherein the cover glass is at or over the front surface of the housing such that the cover glass is positioned over the display and protects the display from damage caused by impact.

Embodiment 27. A method of strengthening a glass, the method comprising:
a. immersing a glass article in an ion exchange medium comprising at least one potassium salt, wherein the at least one potassium salt comprises about 50 wt % of the ion exchange medium, wherein the glass article comprises an alkali aluminosilicate glass, the alkali aluminosilicate glass comprising about 17 or more mol % Al₂O₃ and non-zero amounts of Na₂O, MgO, and CaO, wherein Al₂O₃(mol %)+RO(mol %)≥21 mol %, where RO(mol %)=MgO(mol %)+CaO(mol %)+ZnO(mol %), and wherein the alkali aluminosilicate glass is substantially free of each SrO, BaO, B₂O₃, P₂O₅, and K₂O; and
b. ion exchanging the glass article while immersed in the ion exchange medium for a predetermined time period in a range from about 1 hour to about 24 hours at a predetermined temperature in a range from about 350° C. to about 480° C. to achieve a compressive layer extending from a surface to a DOC and comprising a peak compressive stress of about 1000 or more MPa.

Embodiment 28. The method of Embodiment 27, further comprising forming the glass article by at least one of fusion drawing, rolling, overflow downdraw, slot forming, updraw, or floatation prior to immersing the glass article in the ion exchange medium.

Embodiment 29. The method of Embodiment 27 or Embodiment 28, further comprising heating the glass article to its 10¹¹ P temperature and quenching the heated glass article to room temperature prior to immersing the glass article in the ion exchange medium.

Embodiment 30. The method of any one of Embodiments 27-29, wherein the peak compressive stress is less than or equal to about 1500 MPa.

Embodiment 31. The method of any one of Embodiments 27-30, wherein the alkali aluminosilicate glass further comprises Li₂O, and wherein the DOC is about 10% or more of thickness.

Embodiment 32. The alkali aluminosilicate glass of any one of Embodiments 27-31, wherein the alkali aluminosilicate glass is ion exchangeable to achieve a depth of layer of potassium ions of from about 4 microns to about 40 microns.

Embodiment 33. The method of any one of Embodiments 27-32, further comprising immersing the glass article in a first ion exchange medium consisting essentially of at least one sodium salt and ion exchanging the glass article while immersed in the first ion exchange medium for a predetermined time period in a range from about 1 hour to about 24 hours at a predetermined temperature in a range from about 350° C. to about 480° C.

These and other aspects, advantages, and salient features will become apparent from the following detailed description, the accompanying drawings, and the appended claims.

### BRIEF DESCRIPTION OF THE DRAWINGS

FIG. 1 is a schematic cross-sectional view of an ion exchanged glass sheet;

FIG. 2 is a schematic cross-sectional view of an ion exchanged glass sheet under bend-induced stress; and

FIG. 3 is a plot of compressive stress versus depth of layer (DOL) of potassium ions measured for ion exchanged glass samples after ion exchange at 410° C. in a molten salt bath of 100% KNO₃ for times ranging from 1 hour to 16 hours.

FIG. 4A is a plan view of an exemplary electronic device incorporating any of the strengthened glasses disclosed herein.

FIG. 4B is a perspective view of the exemplary electronic device of FIG. 4A.

### DETAILED DESCRIPTION

In the following description, like reference characters designate like or corresponding parts throughout the several views shown in the figures. Directional terms as used herein—for example up, down, right, left, front, back, top, bottom, inward, outward—are made only with reference to the figures as drawn and are not intended to imply absolute orientation. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the term “glass article” is used in its broadest sense to include any object made wholly or partly of glass, including glass-ceramic. Unless otherwise specified, all compositions of the glasses described herein are expressed in terms of mole percent (mol %). The compositions of all molten salt baths—as well as any other ion exchange media—that are used for ion exchange are expressed in weight percent (wt %). Coefficients of thermal expansion (CTE) are expressed in terms of parts per million (ppm)/° C. and represent a value measured over a temperature range from about 20° C. to about 300° C., unless otherwise specified. High temperature (or liquid) coefficients of thermal expansion (high temperature CTE) are also expressed in terms of part per million (ppm) per degree Celsius (ppm/° C.), and represent a value measured in the high temperature plateau or transformation region of the instantaneous coefficient of thermal expansion (CTE) vs. temperature curve. The high temperature CTE measures the volume change associated with heating or cooling of the glass through the plateau or transformation region.

Unless otherwise specified, all temperatures are expressed in terms of degrees Celsius (° C.). As used herein, the term “softening point” refers to the temperature at which the viscosity of a glass is approximately 1076 poise (P); the term “anneal point” refers to the temperature at which the viscosity of a glass is approximately 10^{13.2} poise; the term “200 poise temperature (T^{200P})” refers to the temperature at which the viscosity of a glass is approximately 200 poise; the term “10¹¹ poise temperature” refers to the temperature at which the viscosity of a glass is approximately 10¹¹ poise; the term “35 kP temperature (T^{35kP})” refers to the temperature at which the viscosity of a glass is approximately 35,000 Poise (P) or 35 kiloPoise (kP); and the term “200 kP temperature (T^{200kP})” refers to the temperature at which the viscosity of a glass is approximately 200 kP.

As used herein, the term “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, a glass that is “substantially free of B₂O₃” is one in which B₂O₃ is not actively added or batched into the glass, but may be present in very small amounts as a contaminant.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, “peak compressive stress” refers to the highest compressive stress value measured within the compressive layer. In some embodiments, the peak compressive stress is located at the surface of the glass. In other embodiments, the peak compressive stress may occur at a depth below the surface, giving the compressive stress profile the appearance of a “buried peak.” Compressive stress (including surface CS) is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

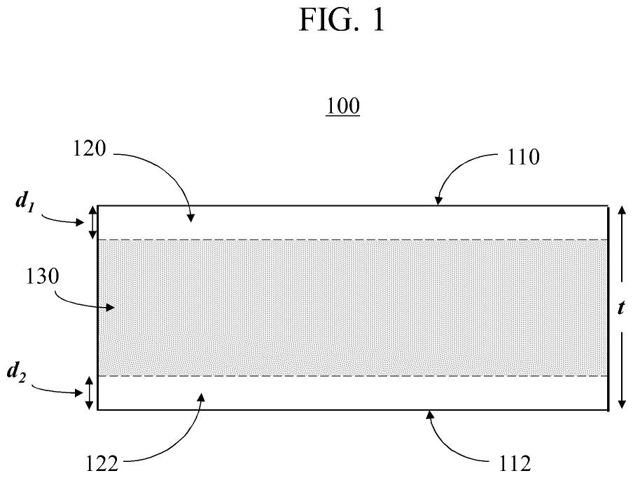

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic views in the interest of clarity and conciseness.

Described herein are alkali aluminosilicate glasses that may be ion exchanged to achieve a peak compressive stress that exceeds compressive stresses that have been achieved in similar glasses. For example, when 1 mm thick coupons of the glasses described herein are ion exchanged in an ion exchange bath of molten potassium nitrate at 410° C. for 45 minutes, a peak compressive stress exceeding about 1000 MPa or, in some embodiments, exceeding about 1050 MPa is obtained. The fictive temperature of these glasses is equal to the 10¹¹ P temperature of the glass.

The glass compositions described herein are formable by processes that include, but are not limited to, fusion draw, overflow, rolling, slot, float processes, or the like. These glasses have a liquidus viscosity in a range from about 5 or more kP to about 200 kP and, in some embodiments, in a range from about 30 or more kP to about 150 kP.

The glasses described herein are ion exchangeable and comprise about 17 or more mol % Al₂O₃, and non-zero amounts of each Na₂O, MgO, and CaO, where Al₂O₃(mol %)+RO(mol %)≥21 mol %, or ≥23 mol %, or ≥24 mol %, where RO is selected from the group consisting of MgO, Ca, and MgO (i.e., RO(mol %)=MgO(mol %)+CaO(mol %)+ZnO(mol %)). In some embodiments, CaO(mol %)/RO(mol %)>0.4, or >0.5, or >0.6. In addition, these glasses are substantially free of each B₂O₃, P₂O₅, K₂O, SrO, and BaO. The alkali aluminosilicate glasses described herein may further include ZnO and Li₂O.

In some embodiments, the alkali aluminosilicate glasses described herein comprise or consist essentially of: from about 52 mol % to about 61 mol % SiO₂; from about 17 mol % to about 23 mol % Al₂O₃; from 0 mol % to about 7 mol % Li₂O; from about 9 mol % to about 20 mol % Na₂O; from greater than 0 mol % to about 5 mol % MgO; from greater than 0 mol % to about 5 mol % CaO; and from greater than 0 mol % to about 2 mol % ZnO. In certain embodiments, the glass comprises: from about 55 mol % to about 61 mol % SiO₂; from about 17 mol % to about 20 mol % Al₂O₃; from 4 mol % to about 7 mol % Li₂O; from about 9 mol % to about 15 mol % Na₂O; from greater than 0 mol % to about 5 mol % MgO; from greater than 0 mol % to about 5 mol % CaO; and from greater than 0 mol % to about 2 mol % ZnO.

Table 1 lists non-limiting, exemplary compositions of the alkali aluminosilicate glasses described herein. Table 2 lists selected physical properties determined for the examples listed in Table 1. The physical properties listed in Table 2 include: density, wherein the density values recited herein were determined using the buoyancy method of ASTM C693-93(2013); low temperature CTE; strain, anneal and softening points, wherein strain points were determined using the beam bending viscosity method of ASTM C598-93(2013), annealing points were determined using the fiber elongation method of ASTM C336-71(2015), and softening points were determined using the fiber elongation method of ASTM C338-93(2013); 10¹¹ Poise, 35 kP, 200 kP, and liquidus temperatures; liquidus viscosities, wherein the liquidus viscosity is determined by the following method. First the liquidus temperature of the glass is measured in accordance with ASTM C829-81 (2015), titled “Standard Practice for Measurement of Liquidus Temperature of Glass by the Gradient Furnace Method”. Next the viscosity of the glass at the liquidus temperature is measured in accordance with ASTM C965-96(2012), titled “Standard Practice for Measuring Viscosity of Glass Above the Softening Point”; Young's modulus, wherein the Young's modulus values recited in this disclosure refer to values as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”; refractive index; and stress optical coefficient for samples listed in Table 1. In some embodiments, the glasses described herein have a Young's modulus of about 80 GPa or more, in other embodiments, from about 80 GPa to about 90 GPa, and, in still other embodiments, from about 80 GPa to about 85 GPa.

TABLE 1
Examples of alkali aluminosilicate glass compositions.

| Analyzed | | | | | | |
|---|---|---|---|---|---|---|
| Composition | | | | | | |
| (mol %) | Ex. 1 | Ex. 2 | Ex. 3 | Ex. 4 | Ex. 5 | Ex. 6 |
| SiO₂ | 60.17 | 60.23 | 58.21 | 56.21 | 54.20 | 52.32 |
| Al₂O₃ | 17.95 | 17.87 | 19.02 | 19.99 | 21.00 | 21.94 |
| Li₂O | 5.78 | 5.68 | 6.11 | 6.43 | 6.71 | 6.98 |
| Na₂O | 11.28 | 11.37 | 11.76 | 12.30 | 12.78 | 13.27 |
| MgO | 4.65 | 0.11 | 2.40 | 2.51 | 2.63 | 2.71 |
| ZnO | 0.00 | 0.00 | 2.35 | 2.42 | 2.53 | 2.63 |
| CaO | 0.07 | 4.64 | 0.04 | 0.04 | 0.04 | 0.05 |
| SnO₂ | 0.10 | 0.10 | 0.10 | 0.10 | 0.10 | 0.10 |
| ZrO₂ | 0.00 | 0.00 | 0.00 | 0.00 | 0.00 | 0.00 |

| Analyzed | | | | | | |
|---|---|---|---|---|---|---|
| Composition | | | | | | |
| (mol %) | Ex. 7 | Ex. 8 | Ex. 9 | Ex. 10 | Ex. 11 | Ex. 12 |
| SiO₂ | 60.23 | 58.29 | 56.29 | 54.47 | 60.10 | 60.25 |
| Al₂O₃ | 18.46 | 19.46 | 20.47 | 21.45 | 17.97 | 17.96 |
| Li₂O | 4.87 | 5.12 | 5.44 | 5.63 | 5.90 | 5.87 |
| Na₂O | 11.79 | 12.28 | 12.76 | 13.25 | 10.29 | 9.29 |
| MgO | 2.33 | 2.42 | 2.52 | 2.59 | 2.88 | 3.30 |
| ZnO | 2.19 | 2.29 | 2.38 | 2.46 | 2.72 | 3.19 |
| CaO | 0.04 | 0.04 | 0.04 | 0.04 | 0.04 | 0.05 |
| SnO₂ | 0.10 | 0.10 | 0.10 | 0.10 | 0.10 | 0.10 |
| ZrO₂ | 0.00 | 0.00 | 0.00 | 0.00 | 0.00 | 0.00 |

| Analyzed | | | | | | |
|---|---|---|---|---|---|---|
| Composition | | | | | | |
| (mol %) | Ex. 13 | Ex. 14 | Ex. 15 | Ex. 16 | Ex. 17 | Ex. 18 |
| SiO₂ | 60.26 | 60.17 | 56.16 | 54.30 | 52.36 | 53.93 |
| Al₂O₃ | 17.45 | 17.46 | 20.58 | 21.56 | 22.63 | 21.55 |
| Li₂O | 5.86 | 5.96 | 0.00 | 0.00 | 0.00 | 2.89 |
| Na₂O | 10.31 | 9.27 | 18.59 | 19.22 | 19.82 | 19.62 |
| MgO | 3.06 | 3.55 | 2.30 | 2.44 | 2.56 | 0.93 |
| ZnO | 2.92 | 3.44 | 2.22 | 2.33 | 2.48 | 0.94 |
| CaO | 0.04 | 0.05 | 0.04 | 0.04 | 0.04 | 0.03 |
| SnO₂ | 0.10 | 0.10 | 0.11 | 0.11 | 0.10 | 0.11 |
| ZrO₂ | 0.00 | 0.00 | 0.00 | 0.00 | 0.00 | 0.00 |
| Analyzed | | | | | | |
| Composition | | | | | | |
| (mol %) | Ex. 19 | Ex. 20 | Ex. 21 | Ex. 22 | Ex. 23 | Ex. 24 |
| SiO₂ | 52.43 | 60.15 | 60.07 | 60.16 | 60.26 | 60.40 |
| Al₂O₃ | 22.54 | 17.82 | 17.78 | 17.83 | 18.03 | 18.05 |
| Li₂O | 2.92 | 5.85 | 5.85 | 5.85 | 6.01 | 5.99 |
| Na₂O | 19.99 | 12.65 | 13.42 | 13.99 | 13.35 | 12.40 |
| MgO | 0.99 | 1.74 | 1.43 | 1.06 | 0.68 | 0.67 |
| ZnO | 0.99 | 1.64 | 1.31 | 0.97 | 0.62 | 0.62 |
| CaO | 0.03 | 0.04 | 0.04 | 0.03 | 0.03 | 0.04 |
| SnO₂ | 0.11 | 0.11 | 0.11 | 0.10 | 0.10 | 0.10 |
| ZrO₂ | 0.00 | 0.00 | 0.00 | 0.00 | 0.92 | 1.73 |
| Analyzed | | | | | | |
| Composition | | | | | | |
| (mol %) | Ex. 25 | Ex. 26 | Ex. 27 | Ex. 28 | Ex. 29 | Ex. 30 |
| SiO₂ | 60.28 | 60.38 | 60.39 | 60.35 | 60.15 | 59.73 |
| Al₂O₃ | 17.97 | 18.01 | 18.02 | 18.04 | 18.00 | 18.51 |
| Li₂O | 6.00 | 6.00 | 6.00 | 6.00 | 5.71 | 5.87 |
| Na₂O | 14.10 | 13.00 | 14.62 | 13.67 | 11.42 | 11.23 |
| MgO | 0.34 | 0.34 | 0.02 | 0.02 | 2.30 | 2.30 |
| ZnO | 0.31 | 0.31 | 0.00 | 0.00 | 0.00 | 0.00 |
| CaO | 0.03 | 0.04 | 0.03 | 0.03 | 2.32 | 2.25 |
| SnO₂ | 0.10 | 0.10 | 0.10 | 0.10 | 0.11 | 0.11 |
| ZrO₂ | 0.87 | 1.83 | 0.83 | 1.78 | 0.00 | 0.00 |
| Analyzed | | | | | | |
| Composition | | | | | | |
| (mol %) | Ex. 31 | Ex. 32 | Ex. 33 | Ex. 34 | Ex. 35 | Ex. 36 |
| SiO₂ | 60.29 | 60.29 | 60.33 | 60.28 | 60.29 | 60.42 |
| Al₂O₃ | 18.51 | 18.48 | 18.47 | 18.53 | 18.51 | 18.04 |
| Li₂O | 5.86 | 5.81 | 5.86 | 5.36 | 5.87 | 2.71 |
| Na₂O | 11.21 | 11.26 | 11.20 | 11.21 | 10.66 | 14.11 |
| MgO | 2.04 | 2.32 | 1.77 | 2.28 | 2.32 | 2.34 |
| ZnO | 0.00 | 0.00 | 0.00 | 0.00 | 0.00 | 0.00 |
| CaO | 2.00 | 1.75 | 2.25 | 2.24 | 2.25 | 2.27 |
| SnO₂ | 0.11 | 0.11 | 0.11 | 0.10 | 0.11 | 0.11 |
| ZrO₂ | 0.00 | 0.00 | 0.00 | 0.00 | 0.00 | 0.00 |
| Analyzed | | | | | | |
| Composition | | | | | | |
| (mol %) | Ex. 37 | Ex. 38 | Ex. 39 | Ex. 40 | Ex. 41 | Ex. 42 |
| SiO₂ | 60.37 | 60.35 | 60.48 | 60.26 | 60.58 | 57.09 |
| Al₂O₃ | 17.97 | 18.53 | 18.65 | 18.99 | 19.08 | 18.55 |
| Li₂O | 0.00 | 2.78 | 0.00 | 2.75 | 0.00 | 8.15 |
| Na₂O | 17.01 | 14.13 | 16.70 | 14.28 | 16.70 | 11.62 |
| MgO | 2.32 | 2.09 | 2.09 | 1.84 | 1.81 | 2.29 |
| ZnO | 0.00 | 0.00 | 0.00 | 0.00 | 0.00 | 0 |
| CaO | 2.23 | 2.00 | 1.97 | 1.77 | 1.72 | 2.19 |
| SnO₂ | 0.11 | 0.11 | 0.11 | 0.11 | 0.11 | 0.11 |
| ZrO₂ | 0.00 | 0.00 | 0.00 | 0.00 | 0.00 | 0 |

TABLE 2
Selected physical properties of the glasses listed in Table 1.

| | Ex. 1 | Ex. 2 | Ex. 3 | Ex. 4 | Ex. 5 | Ex. 6 |
|---|---|---|---|---|---|---|
| Density (g/cm³) | 2.47 | 2.491 | 2.51 | 2.521 | 2.531 | 2.539 |
| FE Strain Pt. (° C.) | 596 | 576 | 588 | 585 | 583 | 583 |
| FE Anneal Pt. (° C.) | 643 | 619 | 635 | 632 | 629 | 628 |
| FE Softening Pt. (° C.) | 868.1 | 838.1 | 856.9 | 850.9 | 841.5 | 835.8 |
| 10¹¹ Poise Temperature (° C.) | 721 | 692 | 712 | 709 | 704 | 701 |
| CTE *10⁻⁷ (1/° C.) | 76.5 | 80.6 | 78 | 79.1 | 81.3 | 82.2 |
| 200 P Temperature (° C.) | 1547 | 1551 | 1526 | 1493 | 1468 | 1448 |
| 35000 P Temperature (° C.) | 1142 | 1119 | 1126 | 1110 | 1092 | 1079 |
| 200000 P Temperature (° C.) | 1054 | 1027 | 1039 | 1025 | 1010 | 1000 |
| Liquidus Temperature (° C.) | 1270 | 1120 | >1255 | >1320 | >1375 | >1305 |
| Liquidus Viscosity (Poise) | 4595 | 34595 | | | | |
| Stress optical coefficient (nm/mm/MPa) | 2.838 | 2.763 | 2.85 | 2.824 | 2.794 | 2.764 |
| Refractive index at 589.3 nm | 1.5175 | 1.5227 | 1.52 | 1.5246 | 1.5254 | 1.5291 |
| Young's Modulus (GPa) | 83.0 | 82.9 | | 83.7 | 84.9 | 85.8 |

| | Ex. 7 | Ex. 8 | Ex. 9 | Ex. 10 | Ex. 11 | Ex. 12 |
|---|---|---|---|---|---|---|
| Density (g/cm³) | 2.502 | 2.513 | 2.523 | 2.532 | 2.512 | 2.521 |
| FE Strain Pt. (° C.) | 601 | 600 | 599 | 599 | 590 | 594 |
| FE Anneal Pt. (° C.) | 651 | 649 | 647 | 645 | 638 | 642 |
| FE Softening Pt. (° C.) | 884.3 | 875.1 | 866.4 | 858.4 | 864.7 | 863.8 |
| 10¹¹ Poise Temperature (° C.) | 733 | 729 | 725 | 720 | 717 | 720 |
| CTE *10⁻⁷ (1/° C.) | 74.5 | 76.6 | 78.3 | 79.1 | 71 | 67.6 |
| 200 P Temperature (° C.) | 1559 | 1533 | 1509 | 1480 | 1537 | 1524 |
| 35000 P Temperature (° C.) | 1156 | 1140 | 1125 | 1107 | 1132 | 1130 |
| 200000 P Temperature (° C.) | 1068 | 1053 | 1041 | 1026 | 1045 | 1045 |
| Liquidus Temperature (° C.) | >1310 | >1320 | >1345 | >1300 | | |
| Liquidus Viscosity (Poise) | | | | | | |
| Stress optical coefficient (nm/mm/MPa) | 2.908 | 2.882 | 2.827 | 2.806 | 2.903 | 2.911 |
| Refractive index at 589.3 nm | 1.5215 | 1.5192 | 1.5239 | 1.5262 | 1.5221 | 1.5246 |
| Young's Modulus (GPa) | 82.3 | 83.0 | 83.7 | 84.6 | 83.9 | 84.7 |
| | Ex. 13 | Ex. 14 | Ex. 15 | Ex. 16 | Ex. 17 | Ex. 18 |
| Density (g/cm³) | 2.516 | 2.527 | 2.523 | 2.535 | 2.543 | 2.508 |
| FE Strain Pt. (° C.) | 583 | 588 | 658 | 659 | 660 | 616 |
| FE Anneal Pt. (° C.) | 630 | 635 | 715 | 713 | 713 | 664 |
| FE Softening Pt. (° C.) | 855 | 854.7 | 955.6 | 945.3 | 945 | 901 |
| 10¹¹ Poise Temperature (° C.) | 708 | 712 | 804 | 798 | 797 | 745 |
| CTE *10⁻⁷ (1/° C.) | 73.2 | 67.9 | 86.4 | 86.5 | 85.1 | |
| 200 P Temperature (° C.) | 1529 | 1519 | 1599 | 1570 | 1564 | 1573 |
| 35000 P Temperature (° C.) | 1124 | 1118 | 1215 | 1199 | 1211 | 1175 |
| 200000 P Temperature (° C.) | 1036 | 1032 | 1133 | 1118 | 1154 | 1097 |
| Liquidus Temperature (° C.) | >1355 | >1380 | >1300 | >1290 | >1325 | |
| Liquidus Viscosity (Poise) | | | | | | |
| Stress optical coefficient (nm/mm/MPa) | 2.876 | 2.895 | 2.982 | 2.938 | 2.891 | 2.846 |
| Refractive index at 589.3 nm | 1.5226 | 1.5248 | 1.5164 | 1.5184 | 1.521 | 1.5173 |
| Young's Modulus (GPa) | 83.7 | 84.9 | 75.9 | 75.9 | 76.9 | 78.7 |

| | Ex. 19 | Ex. 20 | Ex. 21 | Ex. 22 | Ex. 23 | Ex. 24 |
|---|---|---|---|---|---|---|
| Density (g/cm³) | 2.515 | 2.492 | 2.486 | 2.479 | 2.491 | 2.509 |
| FE Strain Pt. (° C.) | 623 | 577 | 573 | 567 | 604 | 618 |
| FE Anneal Pt. (° C.) | 672 | 626 | 620 | 616 | 654 | 670 |
| FE Softening Pt. (° C.) | 909 | 861.5 | 855.4 | 854.6 | 890 | 906.2 |
| 10¹¹ Poise Temperature (° C.) | 754 | 707 | 700 | 698 | 736 | 754 |
| CTE *10⁻⁷ (1/° C.) | | 82.4 | 85.6 | 88.3 | 84.9 | 82 |
| 200 P Temperature (° C.) | 1565 | 1567 | 1569 | 1579 | | |
| 35000 P Temperature (° C.) | 1210 | 1141 | 1142 | 1142 | | |
| 200000 P Temperature (° C.) | 1166 | 1050 | 1048 | 1046 | | |
| Liquidus Temperature (° C.) | | 1255 | 1205 | 1185 | >1315 | >1355 |
| Liquidus Viscosity (Poise) | | 5906 | 12734 | 17576 | | |
| Stress optical coefficient (nm/mm/MPa) | 2.822 | 2.882 | 2.865 | 2.859 | 2.919 | 2.962 |
| Refractive index at 589.3 nm | 1.519 | 1.51806 | 1.516937 | 1.51592 | 1.5197 | 1.5237 |
| Young's Modulus (GPa) | 79.4 | 81.4 | 80.6 | 80.3 | 81.0 | 82.0 |

| | Ex. 25 | Ex. 26 | Ex. 27 | Ex. 28 | Ex. 29 | Ex. 30 |
|---|---|---|---|---|---|---|
| Density (g/cm³) | 2.485 | 2.505 | 2.476 | 2.497 | 2.481 | 2.48 |
| FE Strain Pt. (° C.) | 598 | 623 | 595 | 634 | 585 | 593 |
| FE Anneal Pt. (° C.) | 648 | 675 | 645 | 685 | 633 | 641 |
| FE Softening Pt. (° C.) | 885.2 | 909.6 | 884.1 | 913.9 | 859.7 | 871 |
| 10¹¹ Poise Temperature (° C.) | 730 | 759 | 728 | 767 | 712 | 721 |
| CTE *10⁻⁷ (1/° C.) | 88.9 | 84.1 | 90.8 | 86.8 | 78.8 | 77.9 |
| 200 P Temperature (° C.) | | | 1595 | | 1560 | 1552 |
| 35000 P Temperature (° C.) | | | 1171 | | 1140 | 1145 |
| 200000 P Temperature (° C.) | | | 1077 | | 1050 | 1056 |
| Liquidus Temperature (° C.) | >1325 | >1330 | 1300 | >1340 | 1090 | 1115 |
| Liquidus Viscosity (Poise) | | | 4969 | | 88874 | 60509 |
| Stress optical coefficient (nm/mm/MPa) | 2.922 | 2.957 | 2.884 | 2.946 | 2.795 | 2.781 |
| Refractive index at 589.3 nm | 1.5218 | 1.5292 | 1.5181 | 1.5219 | 1.5197 | 1.520247 |
| Young's Modulus (GPa) | 80.7 | 81.6 | 79.7 | 80.6 | 82.9 | |

| | Ex. 31 | Ex. 32 | Ex. 33 | Ex. 34 | Ex. 35 | Ex. 36 |
|---|---|---|---|---|---|---|
| Density (g/cm³) | 2.474 | 2.473 | 2.475 | 2.478 | 2.476 | 2.482 |
| FE Strain Pt. (° C.) | 597 | 598 | 597 | 602 | 601 | 608 |
| FE Anneal Pt. (° C.) | 646 | 647 | 646 | 652 | 650 | 660 |
| FE Softening Pt. (° C.) | 878.5 | 880.9 | 880 | 883.6 | 883 | 902.3 |
| 10¹¹ Poise Temperature (° C.) | 727 | 728 | 727 | 734 | 731 | 745 |
| CTE *10⁻⁷ (1/° C.) | 78.3 | 77.5 | 78.5 | 76. | 75.6 | 81.5 |
| 200 P Temperature (° C.) | 1561 | 1588 | 1577 | 1556 | 1556 | 1599 |
| 35000 P Temperature (° C.) | 1157 | 1153 | 1152 | 1155 | 1154 | 1181 |
| 200000 P Temperature (° C.) | 1067 | 1065 | 1064 | 1066 | 1065 | 1090 |
| Liquidus Temperature (° C.) | 1090 | 1090 | 1095 | 1095 | 1095 | 1140 |
| Liquidus Viscosity (Poise) | 124655 | 117762 | 103829 | 110058 | 106882 | 74117 |
| Stress optical coefficient | 2.806 | 2.793 | 2.786 | 2.787 | 2.807 | 2.839 |
| (nm/mm/MPa) | | | | | | |
| Refractive index at 589.3 nm | 1.519127 | 1.518623 | 1.519293 | 1.519347 | 1.519923 | 1.515857 |
| Young's Modulus (GPa) | | | | | | |

| | Ex. 37 | Ex. 38 | Ex. 39 | Ex. 40 | Ex. 41 |
|---|---|---|---|---|---|
| Density (g/cm³) | 2.482 | 2.479 | 2.478 | 2.477 | 2.476 |
| FE Strain Pt. (° C.) | 657 | 619 | 672 | 630 | 683 |
| FE Anneal Pt. (° C.) | 712 | 671 | 727 | 682 | 740 |
| FE Softening Pt. (° C.) | 963.3 | 919.3 | 983.1 | 929 | 999.5 |
| 10¹¹ Poise Temperature (° C.) | 801 | 757 | 817 | 768 | 832 |
| CTE *10⁻⁷ (1/° C.) | 84.4 | 81.4 | 82.2 | 81.4 | 81.4 |
| 200 P Temperature (° C.) | 1645 | 1604 | 1647 | 1608 | 1653 |
| 35000 P Temperature (° C.) | 1240 | 1195 | 1248 | 1205 | 1262 |
| 200000 P Temperature (° C.) | 1149 | 1105 | 1159 | 1115 | 1174 |
| Liquidus Temperature (° C.) | 1220 | 1165 | 1210 | 1170 | 1210 |
| Liquidus Viscosity (Poise) | 49909 | 60786 | 70870 | 66371 | 94130 |
| Stress optical coefficient (nm/mm/MPa) | 2.902 | 2.858 | 2.925 | 2.864 | 2.928 |
| Refractive index at 589.3 nm | 1.511721 | 1.515112 | 1.511117 | 1.514749 | 1.51031 |
| Young's Modulus (GPa) | | | | | |

| | Ex. 42 |
|---|---|
| Density (g/cm³) | 2.486 |
| FE Strain Pt. (° C.) | 542 |
| FE Anneal Pt. (° C.) | 587 |
| FE Softening Pt. (° C.) | |
| 10¹¹ Poise Temperature (° C.) | |
| CTE *10⁻⁷ (1/° C.) | 84.4 |
| 200 P Temperature (° C.) | 1480 |
| 35000 P Temperature (° C.) | 1065 |
| 200000 P Temperature (° C.) | 978 |
| Liquidus Temperature (° C.) | 1075 |
| Liquidus Viscosity (Poise) | 29284 |
| Stress optical coefficient (nm/mm/MPa) | 27.78 |
| Refractive index at 589.3 nm | 1.52 |
| Young's Modulus (GPa) | |

Each of the oxide components of the base and ion exchanged glasses described herein serves a function and/or has an effect on the manufacturability and physical properties of the glass. Silica (SiO₂), for example, is the primary glass forming oxide, and forms the network backbone for the molten glass. Pure SiO₂ has a low CTE and is alkali metal-free. The relatively low amount (i.e., 61 mol % or less) of SiO₂ relative to glasses like soda-lime silicate glasses, for example, is advantageous for improving or increasing the peak compressive stress when the glass is ion exchanged. In some embodiments, the glasses described herein comprise from about 52 mol % to about 61 mol % SiO₂, in other embodiments, from about 55 mol % to about 61 mol % SiO₂, and in still other embodiments, from about 58 mol % to about 61 mol % SiO₂.

In addition to silica, the glasses described herein comprise about 17 or more mol % of the network former Al₂O₃. Alumina is present in this amount to achieve stable glass formation, the desired peak compressive stress, diffusivity during ion exchange, and Young's modulus, and to facilitate melting and forming. Like SiO₂, Al₂O₃ contributes to the rigidity to the glass network. Alumina can exist in the glass in either fourfold or fivefold coordination, which increases the packing density of the glass network and thus increases the compressive stress resulting from chemical strengthening. In some embodiments, the glasses described herein comprise from about 17 mol % or 18 mol % to about 23 mol % Al₂O₃ and, in particular embodiments, from about 17 mol % or 18 mol % to about 20 mol %, or to about 21 mol % Al₂O₃. The amount of alumina in these glasses may be limited to lower values in order to achieve high liquidus viscosity.

As described herein, the glasses described herein are substantially free of or include 0 mol % of each of P₂O₅, B₂O₃, K₂O, SrO, and BaO. These oxides are intentionally excluded from the glass, as they tend to reduce Young's modulus and the compressive stress achieved via ion exchange.

The alkali oxide Na₂O is used to achieve chemical strengthening of the glass by ion exchange. The glasses described herein include Na₂O, which provides the Na⁺ cation which is to be exchanged for potassium cations present in a salt bath containing at least one potassium salt such as, for example, KNO₃. In some embodiments, the glasses described herein comprise from about 9 mol %, or about 10 mol %, or about 11 mol %, or about 12 mol % to about 15 mol %, or about 16 mol %, or about 17 mol %, or about 18 mol %, or about 19 mol % or about 20 mol % Na₂O. In other embodiments, these glasses comprise from about 9 mol % to about 15 mol % Na₂O.

The glasses described herein may, in some embodiments, further include Li₂O in an amount up to about 9 mol %, or up to about 8.5 mol %, or up to about 8 mol %, or up to about 7.5 mol %, or up to about 7 mol %. In some embodiments, the glass comprises from about 2 mol % or from about 3 mol % or from about 4 mol % to about 6 mol %, or about 7 mol %, or about 7.5 mol %, or about 8 mol %, or about 8.5 mol %, or about 9 mol % Li₂O. In certain embodiments, the glasses are free of Li₂O (i.e., contain 0 mol % Li₂O), or are substantially free of Li₂O. The presence of Li₂O boosts peak compressive stress and, if desired, enables rapid ion-exchange to a DOL and/or to a deep DOC. In addition, compared to other alkali oxide ions, Li₂O improves both Young's modulus and fracture toughness of the glass. When lithium-containing glasses are ion exchanged, a depth of the compressive layer DOC of 100 or more μm may be achieved in relatively short time periods. As used herein, DOC means the depth at which the stress in the chemically strengthened alkali aluminosilicate glass article described herein changes from compressive to tensile. DOC may be measured by FSM or a scattered light polariscope (SCALP) depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM, and is denoted by depth of layer (DOL) of potassium ions. Tensile stress, or central tension (CT) values, including maximum CT values, are measured using a scattered light polariscope (SCALP) technique known in the art. Unless stated otherwise, the CT values reported herein are maximum CT.

As described hereinabove, the glasses described herein, as originally formed, contain 0 mol % K₂O or are substantially free of K₂O. The presence of potassium oxide in the glass has a negative effect on the ability to achieve high levels of peak compressive stress in the glass through ion exchange. However, after ion exchange, the compressive layer resulting from ion exchange will contain potassium. The ion-exchanged layer near the surface of the glass may contain 10 mol % or more K₂O at the glass surface, while the bulk of the glass at depths greater than the DOL may remain essentially potassium-free, or may remain at a level consistent with that in the bulk of the starting composition.

In some embodiments, the glasses described herein may comprise from 0 mol % up to about 6 mol %, or from greater than 0 mol % to about 4 mol % or to about 6 mol % ZnO. The divalent oxide ZnO improves the melting behavior of the glass by reducing the temperature at 200 poise viscosity (200P temperature). ZnO also helps improve the strain point when compared to like additions of Na₂O. In some embodiments, these glasses comprise from greater than 0 mol % to about 2 mol % ZnO.

In order to reduce the 200P temperature and improve the strain point of the glasses having a liquidus viscosity of greater than 50 kP, alkaline earth oxides such as MgO and CaO may be present in these glasses. In some embodiments, the glasses described herein include from greater than 0 mol % up to 6 mol % MgO or, in other embodiments, these glasses comprise from 0.02 mol % to about 3 mol %, or to about 4 mol %, or to about 5 mol %, or to about 6 mol % MgO. In some embodiments, the glasses described herein comprise from greater than 0 mol % to about 5 mol % CaO, in other embodiments, from 0.03 mol % to about 5 mol % CaO, and, in still other embodiments, from about 0.03 mol % to about 1 mol %, or to about 1.5 mol %, or to about 2 mol %, or to about 2.5 mol %, or to about 3 mol % CaO. As seen in the examples listed in Tables 1 and 2, CaO is present in glasses having a liquidus viscosity greater than 50 kP, which liquidus viscosity makes the glasses readily fusion formable. In some embodiments, as when the glass will be fusion-formed, it is desirable to have a liquidus viscosity greater than 50 kP. In other embodiments, where the glass may be formed by techniques other than fusion forming, the liquidus viscosity may be less than or equal to 50 kP. The alkaline earth oxides SrO and BaO are less effective in reducing the melt temperature at 200 poise viscosity than ZnO, MgO, or CaO and are also less effective than ZnO, MgO, or CaO at increasing the strain point. Hence, the glasses described herein contain divalent oxides selected from the group consisting of ZnO, MgO, and CaO, and are substantially free of or contain 0 mol % of each SrO and BaO.

In some embodiments, Al₂O₃(mol %)+RO(mol %)≥21 mol %; in other embodiments, Al₂O₃(mol %)+RO(mol %)≥22 mol %; in other embodiments, Al₂O₃(mol %)+RO(mol %)≥23 mol %; in other embodiments, Al₂O₃(mol %)+RO(mol %)≥24 mol %; and, in still other embodiments, Al₂O₃(mol %)+RO(mol %)≥25 mol %, where RO(mol %)=MgO(mol %)+CaO(mol %)+ZnO(mol %). In some embodiments, CaO(mol %)/RO(mol %)>0.4; or, in some embodiments, CaO(mol %)/RO(mol %)>0.5; or, in still other embodiments, CaO(mol %)/RO(mol %)>0.6.

In some embodiments, the glasses described herein are chemically strengthened by ion exchange. In at least one example of the process, alkali cations within a source of such cations (e.g., a molten salt or “ion exchange” bath) are exchanged with smaller alkali cations within the glass to achieve a layer that is under a compressive stress (CS) near the surface of the glass. The compressive layer extends from the surface to a depth of compression (DOC) within the glass. In the glasses described herein, for example, potassium ions from the cation source are exchanged for sodium ions and/or, in some embodiments, lithium, within the glass during ion exchange by immersing the glass in a molten salt bath comprising a potassium salt such as, but not limited to, potassium nitrate (KNO₃). In some embodiments, the ion exchange bath may consist essentially of a potassium salt or salts. Other potassium salts that may be used in the ion exchange process include, but are not limited to, potassium chloride (KCl), potassium sulfate (K₂SO₄), and combinations thereof, for example. The ion exchange baths described herein may contain alkali metal ions other than potassium and the corresponding potassium salts. For example, the ion exchange bath may also include sodium salts such as sodium nitrate, sodium sulfate, and/or sodium chloride, for example. In some embodiments, the ion exchange bath may comprise a mixture of KNO₃ and sodium nitrate (NaNO₃). In some embodiments, the ion exchange bath may comprise up to about 50 wt %, or up to about 25 wt % NaNO₃, with the balance of the bath being KNO₃. In other embodiments, the glass may be first ion exchanged in a bath comprising about 100 wt % of a sodium salt (e.g., Na₂SO₄, NaCl, or the like) and then ion exchanged in a second bath comprising the sodium salt and the corresponding potassium salt (e.g., a bath comprising NaNO₃ and KNO₃), or 100 wt % of the corresponding potassium salt (e.g., a first ion exchange bath comprising NaNO₃ and a second ion exchange bath comprising KNO₃) to achieve a deeper DOL and/or a deeper DOC.

A cross-sectional schematic view of a planar ion exchanged glass article is shown in FIG. 1. Glass article 100 has a thickness t, first surface 110, and second surface 112, with the thickness t being, for example, in a range from about 25 μm to about 4 mm. In some embodiments the thickness t is in a range from about 25 μm up to about 50 μm, or up to about 55 μm, or up to about 60 μm, or up to about 65 μm, or up to about 70 μm, or up to about 75 μm, or up to about 80 μm, or up to about 85 μm, or up to about 90 μm, or up to about 95 μm, or up to about 100 μm, or up to about 105 μm, or up to about 110 μm, or up to about 115 μm, or up to about 120 μm, or up to about 125 μm. In certain other embodiments, thickness t is in a range from about 10 μm to about 20 μm. While FIG. 1 depicts glass article 100 as a flat planar sheet or plate, glass article 100 may have other configurations, such as three-dimensional shapes or non-planar configurations. Glass article 100 has a first compressive layer 120 extending from first surface 110 to a first DOC at depth d₁ into the bulk of the glass article 100. In FIG. 1, glass article 100 also has a second compressive layer 122 extending from second surface 112 to a second DOC at depth d₂. Glass article 100 also has a central region 130 that extends between d₁ and d₂. Central region 130 is typically under a tensile stress or central tension (CT), which balances or counteracts the compressive stresses of layers 120 and 122. The depths d₁, d₂ of first and second compressive layers 120, 122, respectively, protect the glass article 100 from the propagation of flaws introduced by sharp impact to first and second surfaces 110, 112 of glass article 100, while the compressive stress minimizes the likelihood of a flaw penetrating through the depths d₁, d₂ of first and second compressive layers 120, 122.

Accordingly, a method of strengthening the glasses described hereinabove such that they are capable of resisting significant bending stresses and achieving high peak compressive stress via ion exchange is provided. A glass article comprising the alkali aluminate glass described hereinabove is immersed in an ion exchange medium, for example, a molten salt bath, a paste, or the like. The ion exchange medium comprises at least one potassium salt, wherein the at least one potassium salt comprises about 50 or more wt % of the ion exchange medium. Prior to immersion, the method may include forming the glass article by those means known in the art, for example, but not limited to, fusion drawing, rolling, overflow drawing, slot forming, updrawing, or floatation. In addition, the glass article, once formed, may be subjected to a heat treatment at a 10¹¹ Poise temperature of the glass article prior to immersion in the ion exchange medium. During immersion in the ion exchange medium, the glass article is ion exchanged in the ion exchange medium for a predetermined time period ranging from about 1 hour to about 24 hours at a predetermined temperature ranging from about 350° C. to about 480° C. (for example from about 350° C. to about 475° C., or from about 350° C. to about 470° C., or from about 350° C. to about 460° C., or from about 350° C. to about 450° C., or from about 350° C. to about 440° C., or from about 350° C. to about 430° C.) to achieve a ion concentration extending from a surface to a DOL, and a compressive layer extending from a surface to a DOC. The compressive layer has a peak compressive stress (wherein in some embodiments the peak compressive stress is at a surface of the ion exchanged glass article) of about 1000 or more MPa or, in some embodiments, about 1050 or more MPa or, in other embodiments, about 1100 or more MPa, or, in still other embodiments, about 1200 or more MPa, and up to about 1500 MPa.

The high peak compressive stresses that may be achieved by ion exchange provide the capability to bend the glass to a tighter (i.e., smaller) bend radius for a given glass thickness. The high peak compressive stress allows the glass to retain net compression and thus contain surface flaws when the glass is subjected to bending around a tight radius. Near-surface flaws cannot extend to failure if they are contained under this net compression or within the effective surface compressive layer.

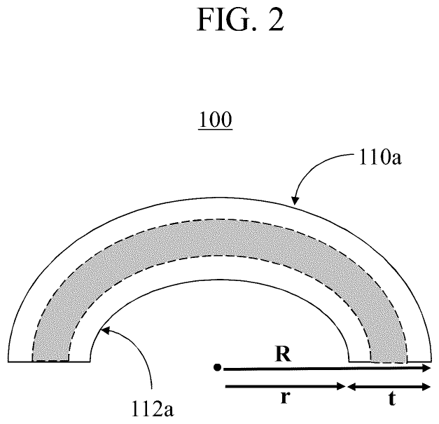

FIG. 2 is a schematic cross-sectional view of an ion exchanged glass sheet under bend-induced stress. When bent to a bend radius R, which is the sum of the thickness t and inner radius r in FIG. 2, the outer surface 110a of the ion-exchanged glass sheet 100 is subjected to a tensile stress from the bending, which causes the DOC on the outer surface 110a to decrease to an effective DOC, while the inner surface 112a is subjected to additional compressive stress from the bending. The effective DOC on the outer surface 110a increases with increasing bend radii and decreases with decreasing bend radii (when the center of curvature is on the side opposite to outer surface 110a, as shown in FIG. 2). When ion exchanged, the glasses described herein, can withstand (without breaking) a bend radius of 3 mm (i.e., R=3 mm) for 60 minutes at about 25° C. and 50% relative humidity. In some embodiments, under the same ambient conditions for the same duration, the glasses described herein, can withstand (without breaking) a bend radius of 4 mm (i.e., R=4 mm). And in still other embodiments, under the same ambient conditions for the same duration, the glasses described herein, can withstand (without breaking) a bend radius of 5 mm (i.e., R=5 mm).

Table 3 lists the peak CS and DOL measured for the samples listed in Table 1 following ion exchange. Glass coupons of 1 mm thickness and having the compositions and physical properties of the examples described in Tables 1 and 2, respectively, were ion exchanged for either 2 hours or 6 hours at 410° C. in a KNO₃ bath. The glass coupons are heat treated at the 10¹¹ Poise (P) temperature and rapidly quenched to room temperature within two minutes to set the fictive temperature to approximately 10¹¹ P viscosity temperature prior to ion-exchange. This is done to set the fictive temperature to represent the thermal history of a fusion drawn sheet. When subjected to ion exchange, the glasses described herein have a compressive layer having a peak compressive stress CS of about 1000 or more MPa or, in some embodiments, about 1050 or more MPa or, in other embodiments, about 1100 or more MPa, or, in still other embodiments, about 1200 or more MPa, up to about 1300 MPa, or to about 1350 MPa, or to about 1400 MPa, or to about 1450 MPa, or to about 1500 MPa. Together with the aforementioned peak CS values, the glasses described herein may achieve a DOL of potassium ions of from about 4 μm to about 40 μm, for example from about 4 μm, or about 5 μm, or about 6 μm, or about 7 μm, or about 8 μm, or about 9 μm, or about 10 μm, or about 11 μm, or about 12 μm, or about 13 μm, or about 14 μm, or about 15 m up to about 40 μm, or about 35 μm, or about 30 μm, or about 25 μm, or about 24 μm, or about 23 μm, or about 22 μm, or about 21 μm, or about 20 μm. In those embodiments in which the glass comprises lithium (Li₂O), the glass may be ion exchanged to peak CS and DOC substantially the same as the CS and DOL described immediately above, as when the ion exchange includes exchanging only potassium ions into the glass, because when only potassium ions are exchanged into the glass, the DOL and DOC are substantially the same. Further, in those embodiments in which the glass comprises lithium (Li₂O) and the ion exchange includes exchanging potassium and sodium ions into the glass, similar peak CS values may be obtained with similar potassium DOL values and/or further may achieve a DOC of greater than 100 μm, for example greater than 110 μm, greater than 120 μm, greater than 130 μm, greater than 140 μm, greater than 150 μm, or greater than 10% of thickness, or greater than 11% of thickness, or greater than 12% of thickness, or greater than 13% of thickness, or greater than 14% of thickness, or greater than 15% of thickness, or greater than 16% of thickness, or greater than 17% of thickness, or greater than 18% of thickness, up to about 24% of thickness.

TABLE 3
Compressive stresses (CS) and DOL are measured for 1 mm thick samples, having
the compositions listed in Table 1 following ion exchange at 410° C. for
2 and 6 hours, respectively, in a 100 wt % KNO₃ molten salt bath.

| | | | | | | |
|---|---|---|---|---|---|---|
| Ex. 1 | Ex. 2 | Ex. 3 | Ex. 4 | Ex. 5 | Ex. 6 | Ex. 7 |

Ion exchanged 2 hours at 410° C.

| | | | | | | | |
|---|---|---|---|---|---|---|---|
| CS (MPa) | 1259 | 1274 | 1351 | 1393 | 1422 | 1395 | 1306 |
| DOL(μm) | 8 | 8 | 9 | 8 | 7 | 7 | 9 |

Ion exchanged 6 hours at 410° C.

| | | | | | | | |
|---|---|---|---|---|---|---|---|
| CS (MPa) | 1192 | 1206 | 1284 | 1323 | 1351 | 1325 | 1241 |
| DOL (μm) | 15 | 15 | 16 | 15 | 14 | 14 | 16 |

| | | | | | | |
|---|---|---|---|---|---|---|
| Ex. 8 | Ex. 9 | Ex. 10 | Ex. 11 | Ex. 12 | Ex. 13 | Ex. 14 |

Ion exchanged 2 hours at 410° C.

| | | | | | | | |
|---|---|---|---|---|---|---|---|
| CS (MPa) | 1365 | 1411 | 1414 | 1276 | 1257 | 1273 | 1253 |
| DOL (μm) | 9 | 8 | 8 | 7 | 6 | 7 | 7 |

Ion exchanged 6 hours at 410° C.

| | | | | | | | |
|---|---|---|---|---|---|---|---|
| CS (MPa) | 1297 | 1340 | 1343 | 1212 | 1194 | 1209 | 1191 |
| DOL (μm) | 16 | 15 | 15 | 14 | 13 | 14 | 14 |

| | | | | | | |
|---|---|---|---|---|---|---|
| Ex. 15 | Ex. 16 | Ex. 17 | Ex. 18 | Ex. 19 | Ex. 20 | Ex. 21 |

Ion exchanged 2 hours at 410° C.

| | | | | | | | |
|---|---|---|---|---|---|---|---|
| CS (MPa) | 1255 | 1275 | 1263 | 1351 | 1378 | 1314 | 1249 |
| DOL (μm) | 21 | 21 | 19 | 21 | 21 | 11 | 13 |

Ion exchanged 6 hours at 410° C.

| CS (MPa) | 1221 | 1239 | 1256 | 1302 | 1339 | 1255 | 1159 |
|---|---|---|---|---|---|---|---|
| DOL (μm) | 35 | 35 | 32 | 35 | 34 | 18 | 22 |
| | Ex. 22 | Ex. 23 | Ex. 24 | Ex. 25 | Ex. 26 | Ex. 27 | Ex. 28 |

Ion exchanged 2 hours at 410° C.

| | | | | | | | |
|---|---|---|---|---|---|---|---|
| CS (MPa) | 1128 | 1217 | 1264 | 1132 | 1231 | 1126 | 1250 |
| DOL (μm) | 23 | 25 | 22 | 27 | 25 | 29 | 29 |

Ion exchanged 6 hours at 410° C.

| CS (MPa) | 1221 | 1239 | 1256 | 1302 | 1339 | 1255 | 1159 |
|---|---|---|---|---|---|---|---|
| DOL (μm) | 35 | 35 | 32 | 35 | 34 | 18 | 22 |
| | Ex. 29 | Ex. 30 | Ex. 31 | Ex. 32 | Ex. 33 | Ex. 34 | Ex. 35 |

Ion exchanged 2 hours at 410° C.

| | | | | | | | |
|---|---|---|---|---|---|---|---|
| CS (MPa) | 1358 | 1315 | 1321 | 1333 | 1334 | 1344 | 1308 |
| DOL (μm) | 8 | 8 | 9 | 9 | 9 | 8 | 8 |

Ion exchanged 6 hours at 410° C.

| | | | | | | | |
|---|---|---|---|---|---|---|---|
| CS (MPa) | 1291 | 1271 | 1273 | 1280 | 1299 | 1305 | 1273 |
| DOL (μm) | 15 | 14 | 15 | 15 | 15 | 14 | 14 |

| | | | | | |
|---|---|---|---|---|---|
| Ex. 36 | Ex. 37 | Ex. 38 | Ex. 39 | Ex. 40 | Ex. 41 |

Ion exchanged 2 hours at 410° C.

| | | | | | | |
|---|---|---|---|---|---|---|
| CS (MPa) | 1280 | 1251 | 1288 | 1239 | 1300 | 1243 |
| DOL (μm) | 13 | 21 | 13 | 22 | 14 | 23 |

Ion exchanged 6 hours at 410° C.

| | | | | | | |
|---|---|---|---|---|---|---|
| CS (MPa) | 1251 | 1227 | 1268 | 1220 | 1280 | 1224 |
| DOL (μm) | 21 | 35 | 23 | 37 | 24 | 39 |

The following examples illustrate the features and advantages of the present disclosure and are in no way intended to limit the disclosure thereto.

### Example 1

Glass samples having a composition (Example 29 in Tables 1-3) and physical properties described in the present disclosure were ion exchanged in three separate molten salt baths: one ion exchange bath containing 100 wt % KNO₃ (Table 4a); a second ion exchange bath containing 50 wt % KNO₃ and 50 wt % NaNO₃ (Table 4b); and a third bath containing 75 wt % KNO₃ and 25 wt % NaNO₃ (Table 4b). Results of these ion exchange experiments in on 1 mm thick glass samples are listed in Tables 4a-4c. The results obtained when samples were ion exchanged in the mixed KNO₃/NaNO₃ baths demonstrate the ability to ion exchange the lithium-containing glasses described herein to attain DOL's in line with the other examples, but much deeper DOCs. For example, the Table 4a examples had DOLs and DOCs (wherein DOC is substantially the same as the DOL for these cases because only KNO₃ was used in the molten salt bath) on the order of about 4 μm to about 15 μm. On the other hand when samples were ion exchanged in the mixed KNO₃/NaNO₃ baths, Tables 4b and 4c show DOLs on the order of about 6 μm to about 8 m and DOCs on the order of about 160 μm to about 170 m (16% or 17% times a thickness of 1 mm). Further, using the bath with the higher percentage of KNO₃ the glass samples achieved similar DOLs and DOCs as the lower percentage KNO₃ bath, but were able to achieve higher CS. In some embodiments, CS on the order of 700 MPa may be useful.

TABLE 4a
Ion exchange data obtained for 1 mm thick glass having the composition
of Example 29 (Table 1) and a fictive temperature of approximately
712° C. The glass samples were ion exchanged at 410° C. or
370° C. in a molten salt bath of 100 wt % KNO₃.

| 410° C. | | | 370° C. | | |
|---|---|---|---|---|---|
| Time (h) | CS (MPa) | DOL (μm) | Time (h) | CS (MPa) | DOL (μm) |
| 1 | 1408 | 6 | 2 | 1432 | 4 |
| 2 | 1358 | 8.4 | 3 | 1373 | 5 |
| 3 | 1347 | 10.7 | 4 | 1355 | 6 |
| 4 | 1337 | 12 | 5 | 1376 | 7 |
| 5 | 1301 | 13.3 | 6 | 1368 | 8 |
| 6 | 1291 | 15.3 | 7 | 1344 | 9 |
| 8 | 1250 | 17 | 8 | 1345 | 10 |
| 16 | 1211 | 23 | | | |

TABLE 4b
Ion exchange data obtained for 1 mm thick glass having the composition
of Example 29 (Table 1) and a fictive temperature of approximately
712° C. The glass was ion exchanged at 380° C. in a molten salt
bath of 50 wt % KNO₃ and 50 wt % NaNO₃.

| Time (h) | CS (MPa) | DOL (μm) | CT (MPa) | DOC (% t) |
|---|---|---|---|---|
| 8 | 542 | 7.6 | 75 | 17 |
| 9 | 563 | 8 | 78 | 17 |

TABLE 4c
Ion exchange data obtained for 1 mm thick glass having the composition
of Example 29 (Table 1) and a fictive temperature of approximately
712° C. the glass was ion exchanged at 380° C. in a molten salt
bath of 75 wt % KNO₃ and 25 wt % NaNO₃.

| Time (h) | CS (MPa) | DOL (μm) | CT (MPa) | DOC (% t) |
|---|---|---|---|---|
| 4 | 690 | 6.1 | 52 | 16 |
| 5 | 719 | 6.2 | 55 | 16 |
| 6 | 706 | 6.9 | 65 | 16 |
| 7 | 709 | 7.3 | 68 | 17 |
| 8 | 710 | 7.6 | 66 | 16 |
| 9 | 697 | 8.3 | 71 | 17 |

### Example 2

Samples having a 100 μm thickness and the composition of Example 29 listed in Table 1 were ion exchanged at 410° C. for 6 hours in a molten salt bath comprising 100 wt % KNO₃ and the compressive stress before and after light etching are shown in Table 5. GORILLA GLASS 2® samples (composition: 70 mol % SiO₂, 10 mol % Al₂O₃, 15 mol % Na₂O, and 5 mol % MgO) having thicknesses of 100 μm, 75 μm, and 50 μm were ion exchanged at 410° C. for 1 hour in a molten salt bath comprising 100 wt % KNO₃ and the compressive stress before and after light etching are shown in Table 5.

In some cases, light etching is applied to samples following ion exchange in order to remove process-induced damage. The light etch comprises an acid which includes fluoride-containing aqueous treating media containing at least one active glass etching compounds elected from the group consisting of HF, combinations of HF with one or more of HCL, H₂NO₃, and H₂SO₄, ammonium bifluoride, sodium bifluoride, and the like. In one particular example, the aqueous acidic solution consists of 5 vol % HF(48%) and 5 vol % H₂SO₄. The etching process is described in U.S. Pat. No. 8,889,254, issued Nov. 18, 2014 and entitled “Impact-Damage-Resistant Glass Sheet” by John Frederick Bayne et al., the contents of which are incorporated herein by reference in their entirety. Accordingly, from the results in Table 5 it is shown that such a light etching process may be performed on the glasses disclosed herein and still have those glasses retain a sufficient amount of compressive stress (in some embodiments a CS greater than or equal to 1000 MPa, and in other embodiments a CS greater than that attained by prior glass compositions (e.g. GORILLA GLASS 2®).

More specifically, as can be seen from the results in Table 5, the glass having the Example 29 composition can be ion exchanged to achieve a significantly greater compressive stress than that achieved with GORILLA GLASS 2®. This result is unexpected in view of the behavior of similar glasses that are ion exchanged under these conditions. Moreover, Table 5 shows that the glasses of the present disclosure are suitable for achieving high CS values in thin glasses, for example glasses having a thickness from about 25 μm to about 125 μm, from about 30 μm to about 120 μm, from about 35 μm to about 115 μm, from about 40 μm to about 110 μm, from about m to about 105 μm, from about 50 μm to about 100 μm, from about 50 m to about 75 μm, or from about 75 μm to about 100 μm.

TABLE 5
Compressive stress for samples of Corning GORILLA
GLASS 2 ® and glass having the composition
of Example 29 (Table 1) following ion exchange at 410°
C., for 6 hours, in a 100 wt % KNO₃ molten salt bath.

| | | | CS after |
|---|---|---|---|
| Thickness (μm) | Glass | CS (MPa) | light etch (MPa) |
| 100 | GORILLA GLASS 2 | 905 | 805 |
| 75 | GORILLA GLASS 2 | 865 | 765 |
| 50 | GORILLA GLASS 2 | 785 | 685 |
| 100 | Ex. 29 | 1205 | 1105 |
| 75 | Ex. 29 | 1165 | 1065 |
| 50 | Ex. 29 | 985 | 885 |

### Example 3

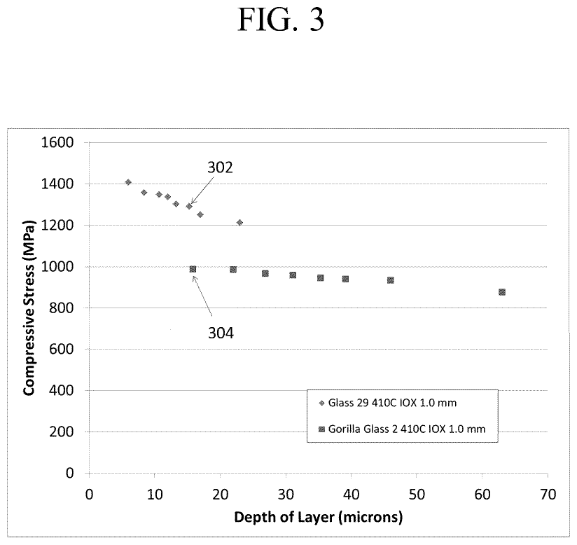

The tightly packed network within the glasses described herein enables high compressive stress to be achieved. Compressive stress at various depths into the glass thickness from the surface are shown in FIG. 3 for 1 mm thick samples of GORILLA GLASS 2® (square data points) and one of the glasses described herein (Example 29 in Tables 1-3, diamond data points) following ion exchange for 1, 2, 3, 4, 5, 6, 8, and 16 hours in a molten salt bath at 410° C. comprising about 100% KNO₃ by weight. For example, point 302 was for the sample of Example 29 glass exchanged for 6 hours and which achieved a peak CS of 1291 and a DOL of 15.3 microns, whereas point 304 was for the sample of GORILLA GLASS 2® exchanged for 1 hour and which achieved a peak CS of 988 and a DOL of 15.8 μm. Thus, for the same DOL of approximately 15 μm, the glasses having the Example 29 composition exhibit peak compressive stresses that are 300 or more MPa greater than those observed for the GORILLA GLASS 2® samples. Over the same range of DOLs of approximately 15 μm to 20 μm, the glasses having the Example 29 composition exhibit peak compressive stresses that are 200 or more MPa greater than those observed for the GORILLA GLASS 2® samples. Although the CS for the Example 29 samples is higher than that of the GORILLA GLASS 2® samples having the same DOL, the time to get the same DOL is higher for the Example 29 samples. The increased processing time may be due to the tightly packed network within the glasses, which may lead to reduced ion diffusivity. However, in some embodiments, the benefit of the increased CS outweighs the longer processing time from the reduced ion diffusivity.

### Example 4

Samples of glass having 1 mm thickness and the composition of Example 42 (having the highest lithium content) in Table 1 were subject to various ion exchange conditions as set forth below in Table 6, including two-step ion exchange processes. The resulting properties are also set forth in Table 6. Because the Example 42 sample has high lithium, it is expected (according to the principles of this disclosure) to have high Young's modulus and fracture toughness. Further, it is expected that the DOCs of these samples will be in the range of 15% to 20% of thickness.

TABLE 6
Ion Exchange Conditions and Resulting Properties for a
glass having the composition of Example 42 (Table 1).

| | | | | |
|---|---|---|---|---|
| | CS | DOL | CT | DOC |
| Ion Exchange Conditions | (MPa) | (μm) | (MPa) | (% t) |

| | | | |
|---|---|---|---|
| 100% NaNO₃ at 280° C. for 16 hours | | | 119 |
| 100% NaNO₃ at 280° C. for 16 hours, | 1157 | 5.5 | 115 |
| then 100% KNO₃ at 410° C. for 1 hour | | | |
| 100% NaNO₃ at 280° C. for 16 hours, | 914 | 9.2 | 92 |
| then 100% KNO₃ at 410° C. for 4 hours | | | |

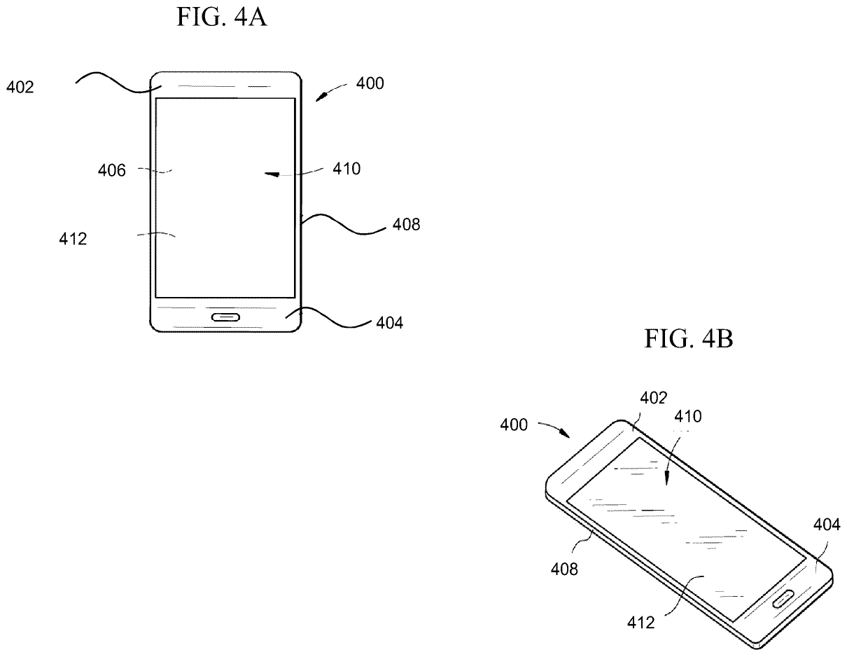

The strengthened glass disclosed herein may be incorporated into another article such as an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the strengthened glass disclosed herein is shown in FIGS. 4A and 4B. Specifically, FIGS. 4A and 4B show a consumer electronic device 400 including a housing 402 having front 404, back 406, and side surfaces 408; electrical components (not shown) that are at least partially inside or entirely within the housing and including a controller, a memory, and a display 410 at or adjacent to the front surface of the housing; and a cover substrate 412 at or over the front surface of the housing such that it is over the display. In some embodiments, at least one of the cover substrate 412 or a portion of housing 402 may include any of the strengthened glass disclosed herein. The cover glass and/or housing has a thickness of from about 0.4 mm to about 4 mm and, when chemically strengthened, a peak compressive stress of about 1000 or more MPa, or about 1050 or more MPa, or about 1100 or more MPa, or about 1200 or more MPa, or about 1250 or more MPa up to about 1300 MPa, or to about 1350 MPa, or to about 1400 MPa, or to about 1450 MPa, or to about 1500 MPa.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

What is claimed is:

1. An ion exchanged glass, wherein the ion exchanged is an alkali aluminosilicate glass comprising:
a. about 17 or more mol % Al₂O₃;
b. Na₂O;
c. MgO; and
d. CaO, wherein Al₂O₃(mol %)+RO(mol %)≥21 mol %, where RO(mol %)=MgO(mol %)+CaO(mol %)+ZnO(mol %), wherein the alkali aluminosilicate glass is substantially free of each SrO, BaO, B₂O₃, P₂O₅, and K₂O, and wherein the ion exchanged glass comprises a thickness of up to about 4 mm comprises a compressive layer extending from a surface of the ion exchanged glass to a DOC, and comprises a peak compressive stress of about 1000 or more MPa.

2. The ion exchanged glass of claim 1, wherein the ion exchanged glass comprises a thickness of up to about 100 μm; wherein the ion exchanged glass comprises an absence of failure when held for 60 minutes at about 25° C. and about 50% relative humidity and at a bend radius of at least one of: 5 mm; 4 mm; or 3 mm; and wherein the peak compressive stress is less than or equal to about 1500 MPa.

3. The ion exchanged glass of claim 2, wherein the ion exchanged glass further comprises Li₂O, and wherein the DOC is about 10% or more of thickness.

4. The alkali aluminosilicate glass of claim 3, wherein the ion exchanged glass comprises a depth of layer of potassium ions of from about 4 microns to about 40 microns.

5. The ion exchanged glass of claim 4, wherein the ion exchanged glass comprises:
from about 52 mol % to about 61 mol % SiO₂; from about 17 mol % to about 23 mol % Al₂O₃; from 0 mol % to about 7 mol % Li₂O; from about 9 mol % to about 20 mol % Na₂O; from greater than 0 mol % to about 5 mol % MgO; from greater than 0 mol % to about 5 mol % CaO; and from greater than 0 mol % to about 2 mol % ZnO.
